(19) United States
(12) Patent Application Publication
(10) Pub. No.: US 2009/0319516 A1
(43) Pub. Date: Dec. 24, 2009

(54) Contextual Advertising Using Video Metadata and Chat Analysis

(75) Inventors: Marvin Igelman, Thornhill (CA); Aleksandar Zivkovic, North York (CA)

Correspondence Address: Sunstein Kann Murphy & Timbers LLP, 125 SUMMER STREET, BOSTON, MA, 02110-1618, US

(73) Assignee: VIEW2GETHER INC., Culver City, CA (US)

(21) Appl. No.: 12/485,790

(22) Filed: Jun. 16, 2009

Related U.S. Application Data
(60) Provisional application No. 61/061,792, filed on Jun. 16, 2008.

(51) Int. Cl. G06F 17/30

(52) U.S. Cl. 707/5; 707/E17.074

(57) ABSTRACT

A method of delivering advertising content over the internet to a selected client, the selected client being one of a plurality of clients causing display of media content synchronously. The method includes receiving chat text from at least one of the plurality of clients, generating a set of keywords using the chat text, receiving advertising content selected on the basis of the set of keywords from an advertising system, and delivering the advertising content to at least the selected client over the internet.

The present application claims priority from U.S. Provisional Application No. 61/061,792, filed Jun. 16, 2008, the full disclosure of which is hereby incorporated by reference herein.

### TECHNICAL FIELD

The present invention relates to methods of delivering advertising content, and more particularly to methods of delivering contextual advertising content over the internet.

### BACKGROUND ART

With the proliferation of Internet videos fueled by the spread of video sharing sites that host content made specifically for the Internet medium and/or content made originally for different media, such as YouTube, MySpace Video and Brightcove, and with the exponential growth of user generated content (UGC), a persistent problem has presented itself: how to serve advertising material that is closely or directly related to the video content being played and that would interest a viewer of the content. The majority of such content is available for end users free of charge. Distribution channels and producers rely almost entirely on advertising to generate revenue. However, due to the nature of UGC and other video material, advertisers cannot determine how to serve ads that are of interest to users.

### SUMMARY OF THE INVENTION

The present invention in one embodiment provides a method of delivering advertising content over the internet to a selected client. The selected client is one of a plurality of clients causing display of media content synchronously. The embodiment includes receiving chat text from at least one of the plurality of clients, and also includes generating a set of the keywords using the chat text. The embodiment further includes receiving advertising content from an advertising system; the advertising content is selected on the basis of the set of keywords. The embodiment also includes delivering the advertising content over the internet to at least the selected client.

In a related embodiment of the present invention, generating the set of keywords includes using the chat text and metadata related to the media content as sources for candidate key words in deriving the set. In a further related embodiment, generating the set of keywords includes generating at least one keyword associated with both the chat text and the metadata.

Alternatively or in addition, generating the set of keywords includes generating at least one keyword on the basis of relative frequency of occurrence of the candidate keywords.

In another related embodiment, generating the set of keywords includes filtering the chat text and the metadata using a set of excluded words. In another related embodiment, the metadata include at least one of a title of the media content, video annotations within the media content, closed captioning information, a list of persons appearing in the media content, a list of places appearing in the media content, a summary of the media content, a review of the media content, a search term that led to displaying the media content, comments from prior viewers of the media content, and a transcript of the media content.

In another related embodiment, delivering the advertising content to at least the selected client includes causing display of the advertising content while also causing display of the media content on at least the selected client. Alternatively or in addition, generating a set of keywords includes ordering the keywords according to a measure of relevance.

In another related embodiment, the method includes providing the set of keywords to the advertising system. Alternatively or in addition, the set of keywords is provided to the advertising system over the internet and the advertising content is received from the advertising system over the internet.

In another related embodiment, receiving the chat text includes at least one of receiving chat text from the selected client and receiving chat text from a client other than the selected client.

Another embodiment is an apparatus for delivering advertising content over the internet to a selected client. The selected client is one of a plurality of clients causing display of media content. The apparatus includes at least one communication interface including an internet interface, a chat text receiver configured to receive chat text from at least one of the plurality of clients during display of the media content, a keyword generator configured to generate a set of keywords using the chat text, an advertisement receiver configured to receive, from an advertising system, advertising content selected on the basis of the set of keywords, and an advertisement transmitter configured to deliver the advertising content over the internet to at least the selected client.

In a related embodiment of the present invention, the keyword generator is further configured to use the chat text and metadata related to the media content as sources for candidate key words in deriving the set. In a further related embodiment, the keyword generator is further configured to generate at least one keyword associated with both the chat text and the metadata.

Alternatively or in addition, the keyword generator is further configured to generate at least one keyword on the basis of relative frequency of occurrence of the candidate keywords.

In another related embodiment, the keyword generator is further configured to filter the chat text and the metadata using a set of excluded words. In another related embodiment, the metadata include at least one of a title of the media content, video annotations within the media content, closed captioning information, a list of persons appearing in the media content, a list of places appearing in the media content, a summary of the media content, a review of the media content, a search term that led to displaying the media content, comments from prior viewers of the media content, and a transcript of the media content.

In another related embodiment, the advertisement transmitter is further configured to cause display of the advertising content while also causing display of the media content on at least the selected client. Alternatively or in addition, the keyword generator is further configured to order the set of keywords according to a measure of relevance.

In another related embodiment, the keyword generator is further configured to provide the set of keywords to the advertising system. Alternatively or in addition, the keyword generator is configured to provide the set of keywords to the advertising system over the internet and the advertisement receiver is configured to receive the advertising content from the advertising system over the internet.

In another related embodiment, the chat text receiver is configured for at least one of receiving chat text from the selected client and receiving chat text from a client other than the selected client.

It should be noted that the apparatus may include multiple communication interfaces such as, for example, an internet interface for receiving chat text and delivering advertising content and a dedicated advertising system interface for providing keywords to the advertising system and receiving advertising content from the advertising system.

Another embodiment is computer program product for use on a computer system for delivering advertising content over the internet to a selected client. The selected client is one of a plurality of clients causing display of media content synchronously. The computer program product includes a computer usable medium having computer readable program code thereon. The computer readable program code includes program code for receiving chat text from at least one of the plurality of clients during display of the media content, program code for generating a set of keywords using the chat text, program code for receiving, from an advertising system, advertising content selected on the basis of the set of keywords, and program code for delivering, over the internet, the advertising content to at least the selected client.

### BRIEF DESCRIPTION OF THE DRAWINGS

The foregoing features of the invention will be more readily understood by reference to the following detailed description, taken with reference to the accompanying drawings, in which:

FIG. 1 is a schematic diagram showing a contextual advertising system in accordance with an exemplary embodiment of the present invention

FIG. 2 is a flow chart of an advertising content delivery process in accordance with an exemplary embodiment of the present invention.

FIG. 3 is a flow chart of a text reception process in accordance with an exemplary embodiment of the present invention.

FIG. 4 is a flow chart of a keyword generation process in accordance with an exemplary embodiment of the present invention.

FIG. 5 is a flow chart of an advertising content reception process in accordance with an exemplary embodiment of the present invention.

FIG. 6 shows a representation of a user interface including a chat interface juxtaposed with a video display in accordance with an exemplary embodiment of the present invention.

FIG. 7 shows a representation of a contextual advertisement displayed in the context of a user interface including a chat interface juxtaposed with a video display in accordance with an exemplary embodiment of the present invention.

### DETAILED DESCRIPTION OF SPECIFIC EMBODIMENTS

Definitions. As used in this description and the accompanying claims, the following terms shall have the meanings indicated, unless the context otherwise requires:

“Chat text” is the text associated with a communication from one user directed to one or more other users during display of the media content, whether relating to the media content or otherwise.

“Metadata” is information, other than chat text, related to or derived from media content, whether provided with the media content or otherwise.

A “set” includes one or more members.

The “internet” is generally used to mean “the Internet” as it is almost universally known, although the term may additionally or alternatively refer to other types of public and/or private networks over which various embodiments of the present invention may operate, such as, for example, local area networks, metropolitan area networks, wide area networks, cellular networks, etc.

Embodiments of the present invention enable serving of highly relevant advertisements related to media (e.g., video) content being viewed and on-site chat discussion. By displaying substantially synchronized videos to all the viewers of a specific webpage and by analyzing metadata related to the media content and chat text by users viewing the video content, embodiments of the present invention identify advertisements that are highly relevant to the content delivered. Delivering substantially synchronous media content in such a manner is described in U.S. Patent Application Publication No. US2009/0106357 published Apr. 23, 2009, the full disclosure of which is hereby incorporated by reference herein. Embodiments of the present invention have wide applicability and can advantageously serve advertisements to interactive environments such as the Internet, an Intranet, desktop systems and mobile devices.

Embodiments of the present invention essentially read the content of the chat text and process the chat text. The system extracts and analyzes the chat material and optionally any available metadata related to the media content to generate highly relevant keywords. The list of highly relevant keywords is sent to an advertising system, which in turn returns relevant ads (e.g., video, banner, text or such other electronic form) to be served in real-time to the user. The served advertisements are thus customized to the specific chat text and/or media content being displayed, which the user is watching and which has captured the interest of the user. This real-time dynamic method serves advertisements that are contextually related to the audiovisual and chat content.

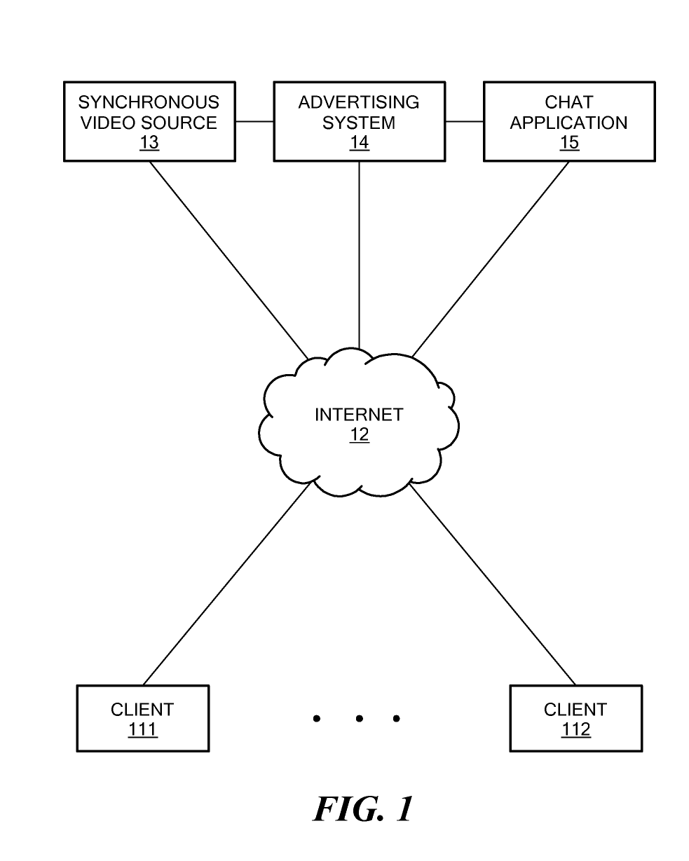

FIG. 1 is a schematic diagram showing a contextual advertising system in accordance with an exemplary embodiment of the present invention. A plurality of web clients such as 111 and 112 are connected to the internet 12. Dots are used in FIG. 1 to indicate that any additional number of clients may be present as well. The clients can synchronously display video content received over the internet while they simultaneously send and receive chat text. For example, suppose several clients are displaying a particular video delivered from a synchronous video source 13, the video retrieved from an online distributor of user generated content (such as YouTube, MySpace Video, Brightcove, etc.), showing actor Pierce Brosnan being interviewed by late-night talk show host David Letterman. For each client that is simultaneously displaying the video, a user may be viewing the video as it is displayed. Let us also suppose that the users are entering chat text into their respective clients while the video is being displayed, and the chat text is being delivered through a chat application 15 from the sending clients to every other client that is displaying the video. The users may thus communicate online about the content of the video while they are watching it. Alternatively, the users could choose to chat about subjects that are not directly related to the video, while they continue to watch the video. Now suppose that in the chat text, actor Sean Connery is mentioned. According to embodiments of the present invention, a set of keywords, including representations of the names “Pierce Brosnan” and “Sean Connery” could be generated using the chat text and metadata associated with the video, and the set of keywords could be delivered to an advertising system 14. The advertising system 14 could then select targeted advertising content that could be delivered to the clients displaying the video, such that the users watching the video are exposed to the advertising content. In this case, the advertising content might include content related to the James Bond franchise, because the keywords included the names of two actors who have both played the character James Bond in the movies. Thus the content of the chat text is leveraged to provide better targeted, contextual advertising content than would be possible using only the context of the video without the information provided by the chat text. Without such additional information, less well-targeted advertisements might be generated, such as advertisements relating to discounts available on director's cut versions of such Pierce Brosnan films as “The Thomas Crown Affair” or “The Tailor of Panama,” when the users viewing the video are actively thinking about and discussing James Bond, and thus would be much more interested to know about the upcoming release of new hardcover reissues of Ian Fleming's original James Bond novels.

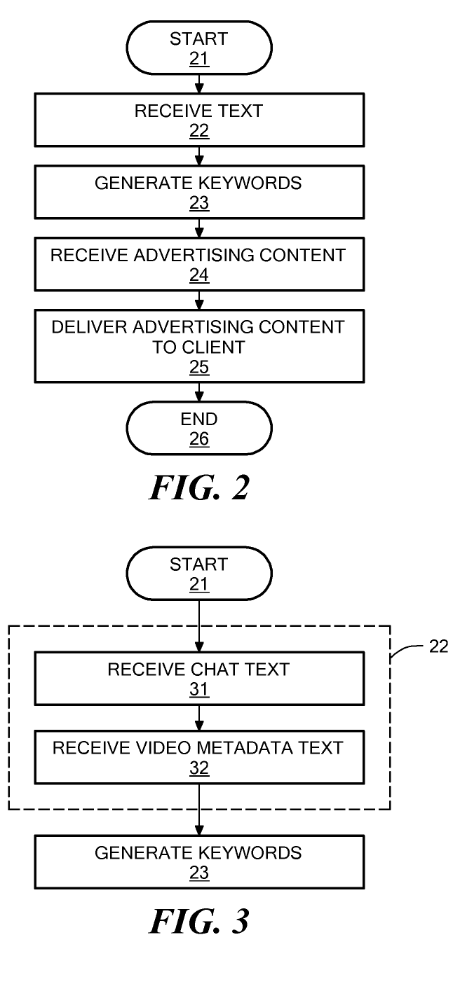

FIG. 2 is a flow chart of an advertising content delivery process in accordance with an exemplary embodiment of the present invention. The process begins in block 21. Block 22 proceeds to receiving text. Thereafter, block 23 shows generating keywords. Block 24 follows, showing receiving advertising content. Block 25 then shows delivering the advertising content to one or more clients. The process ends in block 26.

FIG. 3 is a flow chart of a text reception process 22 in accordance with an exemplary embodiment of the present invention. In FIG. 3, the process of receiving text 22 is shown in greater detail. As shown in block 31, receiving text includes receiving chat text. While various users are watching a video displayed by the clients, the users can chat with each other over the internet. Text sent as part of such chats is collected and can then be used to determine what advertising content will be most relevant to the users.

As shown in block 32, receiving text also can include receiving video metadata text. The video being displayed by the clients may have useful associated metadata available. Such metadata could include a title of the video, video annotations within the video, a transcript of the video, closed captioning information, and so on. Video content retrieved from a source such as YouTube might have comments, left by previous viewers of the video, available as metadata as well. Further possible metadata might include a list of persons, places, etc. appearing in the video, a summary or review of the video, a subject or search term that led to displaying the video, etc. Receiving metadata text in block 32 may involve actively obtaining information from third-party sources (e.g., online databases or search engines) such as, for example, actively obtaining a transcript or review of the video based on its title.

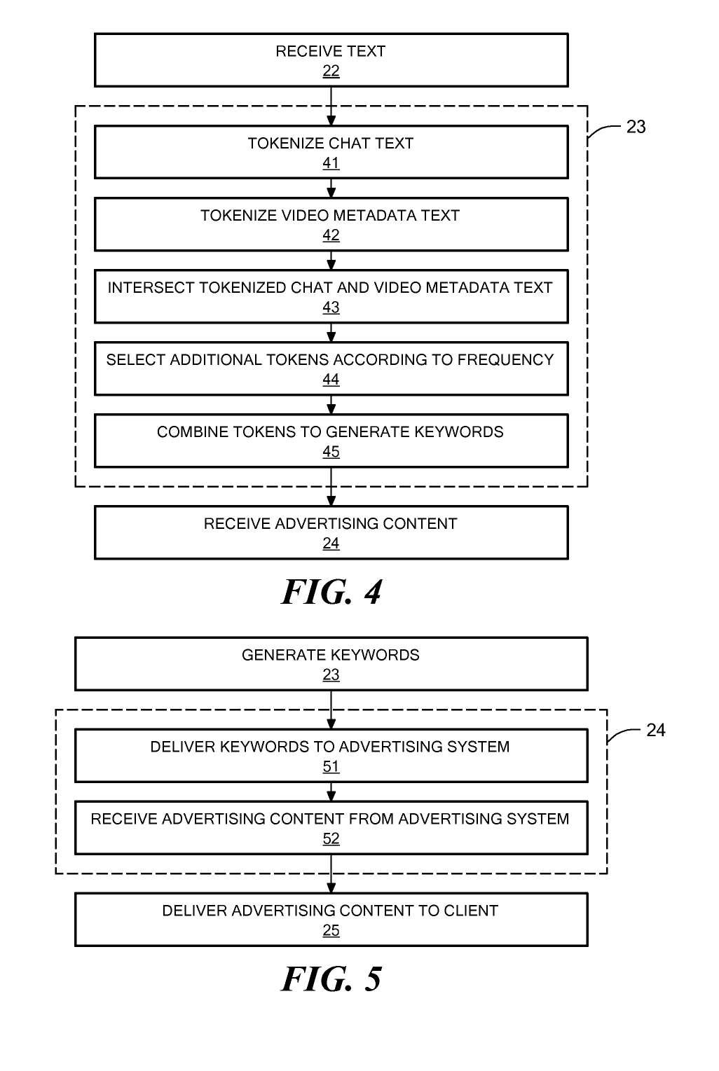

FIG. 4 is a flow chart of a keyword generation process 23 in accordance with an exemplary embodiment of the present invention. In FIG. 4, the process of generating keywords is shown in greater detail. Block 41 shows tokenizing the chat text that was received in block 31 of FIG. 3. Similarly, block 42 shows tokenizing the video metadata text that was received in block 32 of FIG. 3. As shown in block 43, generating keywords then includes intersecting the tokenized chat text and video metadata text. Intersecting in block 43 may include, for example, identifying words that are in both the tokenized chat text and the tokenized metadata, identifying a common theme between the tokenized chat text and the tokenized metadata (e.g., both relate to science fiction), inferring an interest of the user based on the chat text in the context of the video (e.g., users are watching a video relating to Chinese cooking and the chat text indicates that dinner plans are being made, which may indicate that advertisements for local Chinese restaurants would be of interest), or other interpretations of the tokenized chat text and tokenized metadata. In some embodiments, the chat text and the metadata may be filtered prior to intersecting using a set of words to exclude (e.g. “the,” “and,” or any other words presumed to be irrelevant). Block 44 shows selecting additional tokens according to frequency. Thus, tokens that were not in the intersection from block 43 may nonetheless be selected if they appear in either the tokenized chat text or the tokenized video metadata text with sufficient frequency that they are deemed likely to be significant. Block 45 shows combining the two sets of tokens identified in blocks 43 and 44 to generate a set of keywords.

FIG. 5 is a flow chart of an advertising content reception process 24 in accordance with an exemplary embodiment of the present invention. In FIG. 5, the process of receiving advertising content is shown in greater detail. As shown in block 51, receiving advertising content includes first delivering keywords to an advertising system. As shown thereafter in block 52, process 24 then includes receiving advertising content from the advertising system in response to the keywords that were submitted in block 51. Advertising content may include video ads, banner ads, text ads, or other such electronic forms of advertisement. Advertisements may be linked such that when a user performs a mouse click on the advertisement, the link is followed over the internet and more information is retrieved relating to the advertisement. Advertisements also may include features such as mouse-over activity, wherein positioning the computer mouse pointer over the advertisement will cause additional material to appear on the screen, either with or without the need to perform a mouse click. The types of advertising material described here are meant to be exemplary, and other forms of advertising content that may be used in practicing embodiments of the present invention will be apparent to those skilled in the art.

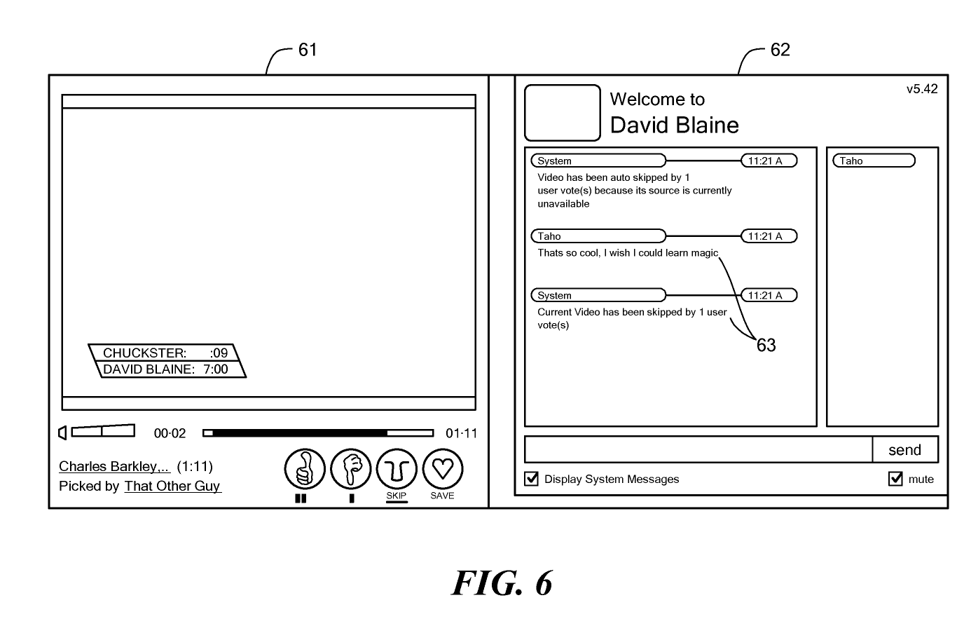

FIG. 6 shows a representation of a user interface including a chat interface 62 juxtaposed with a video display 61 in accordance with an exemplary embodiment of the present invention. Video is displayed by a client in a video display 61. A chat interface 62 is then juxtaposed with the video display 61, such that a user viewing the video can send and receive chat text 63 through the chat interface 62 at the same time as the user views the video.

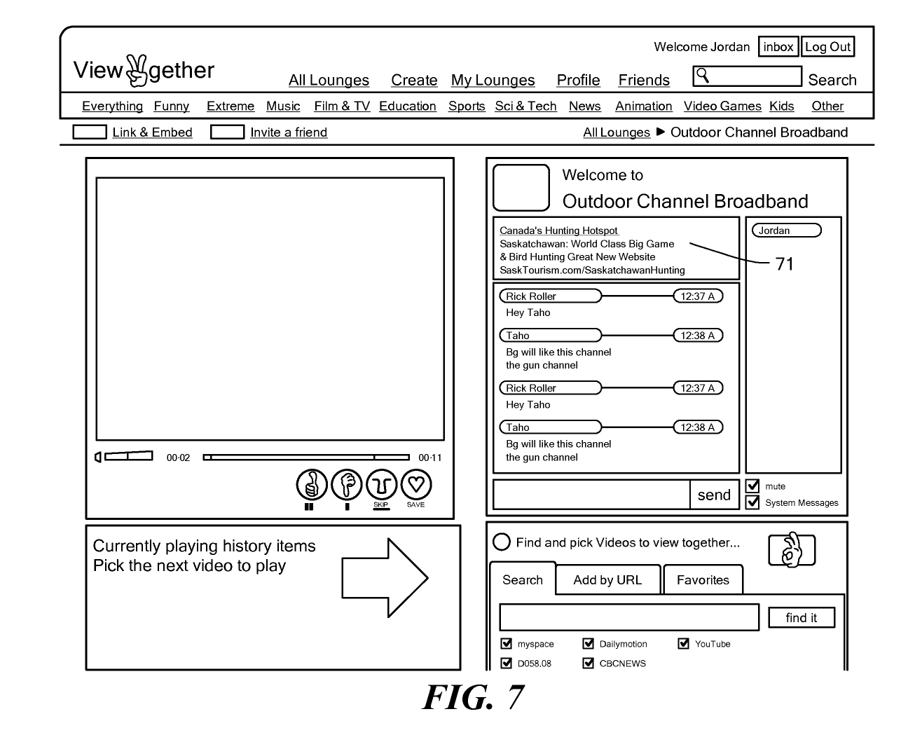

FIG. 7 shows a representation of a contextual advertisement displayed in the context of a user interface including a chat interface juxtaposed with a video display in accordance with an exemplary embodiment of the present invention. Similarly to FIG. 6, FIG. 7 shows a video display juxtaposed with a chat interface. In this case, a contextual advertisement 71 is shown that has been inserted into the user interface in a prominent location.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof.

Computer program logic implementing all or part of the functionality previously described herein may be embodied in various forms, including, but in no way limited to, a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), a PC card (e.g., PCMCIA card), or other memory device. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable memory), a magnetic memory device (e.g., a diskette or fixed disk), an optical memory device (e.g., a CD-ROM), or other memory device. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A computer-implemented method of delivering advertising content over the internet to a selected client, wherein the selected client is one of a plurality of clients causing display of media content synchronously, the method comprising:
in a first computer process, receiving chat text from at least one of the plurality of clients during display of the media content;
in a second computer process, generating a set of keywords using the chat text;
in a third computer process, receiving, from an advertising system, advertising content selected on the basis of the set of keywords; and
in a fourth computer process, delivering, over the internet, the advertising content to at least the selected client.

2. A method according to claim 1, wherein generating the set of keywords includes using the chat text and metadata related to the media content as sources for candidate key words in deriving the set.

3. A method according to claim 2, wherein generating the set of keywords includes generating at least one keyword associated with both the chat text and the metadata.

4. A method according to claim 2, wherein generating the set of keywords further includes generating at least one keyword on the basis of relative frequency of occurrence of the candidate keywords.

5. A method according to claim 2, wherein generating the set of keywords includes filtering the chat text and the metadata using a set of excluded words.

6. A method according to claim 2, wherein the metadata include at least one of:
a title of the media content;
video annotations within the media content;
closed captioning information;
a list of persons appearing in the media content;
a list of places appearing in the media content;
a summary of the media content;
a review of the media content;
a search term that led to displaying the media content;
comments from prior viewers of the media content; and
a transcript of the media content.

7. A method according to claim 1, wherein delivering the advertising content to at least the selected client includes causing display of the advertising content while also causing display of the media content on at least the selected client.

8. A method according to claim 1, wherein generating a set of keywords includes ordering the keywords according to a measure of relevance.

9. A method according to claim 1, further comprising:
providing the set of keywords to the advertising system.

10. A method according to claim 9, wherein the set of keywords is provided to the advertising system over the internet and wherein the advertising content is received from the advertising system over the internet.

11. A method according to claim 1, wherein receiving the chat text includes at least one of:
receiving chat text from the selected client; and
receiving chat text from a client other than the selected client.

12. Apparatus for delivering advertising content over the internet to a selected client, wherein the selected client is one of a plurality of clients causing display of media content, the apparatus comprising:
at least one communication interface including an internet interface;
a chat text receiver configured to receive chat text from at least one of the plurality of clients during display of the media content;
a keyword generator configured to generate a set of keywords using the chat text;
an advertisement receiver configured to receive, from an advertising system, advertising content selected on the basis of the set of keywords; and
an advertisement transmitter configured to deliver the advertising content over the internet to at least the selected client.

13. Apparatus according to claim 12, wherein the keyword generator is further configured use the chat text and metadata related to the media content as sources for candidate key words in deriving the set.

14. Apparatus according to claim 13, wherein the keyword generator is further configured to generate at least one keyword associated with both the chat text and the metadata.

15. Apparatus according to claim 12, wherein the keyword generator is further configured to generate at least one keyword on the basis of relative frequency of occurrence of the candidate keywords.

16. Apparatus according to claim 12, wherein the keyword generator is further configured to filter the chat text and the metadata using a set of excluded words.

17. Apparatus according to claim 12, wherein the metadata include at least one of:
a title of the media content;
video annotations within the media content;
closed captioning information;
a list of persons appearing in the media content;
a list of places appearing in the media content;
a summary of the media content;
a review of the media content;
a search term that led to displaying the media content;
comments from prior viewers of the media content; and
a transcript of the media content.

18. Apparatus according to claim 11, wherein the advertisement transmitter is further configured to cause display of the advertising content while also causing display of the media content on at least the selected client.

19. Apparatus according to claim 11, wherein the keyword generator is further configured to order the keywords according to a measure of relevance.

20. Apparatus according to claim 11, wherein the keyword generator is further configured to provide the set of keywords to the advertising system.

21. Apparatus according to claim 20, wherein the keyword generator is configured to provide the set of keywords to the advertising system over the internet and the advertisement receiver is configured to receive the advertising content from the advertising system over the internet.

22. Apparatus according to claim 11, wherein the chat text receiver is configured for at least one of:
receiving chat text from the selected client; and
receiving chat text from a client other than the selected client.

23. A computer program product for use on a computer system for delivering advertising content over the internet to a selected client, wherein the selected client is one of a plurality of clients causing display of media content synchronously, the computer program product comprising a computer usable medium having computer readable program code thereon, the computer readable program code comprising:
program code for receiving chat text from at least one of the plurality of clients during display of the media content;
program code for generating a set of keywords using the chat text;
program code for receiving, from an advertising system, advertising content selected on the basis of the set of keywords; and
program code for delivering, over the internet, the advertising content to at least the selected client.
